(19) United States
(12) Patent Application Publication
(10) Pub. No.: US 2010/0258348 A1
(43) Pub. Date: Oct. 14, 2010

(54) INTERCONNECT AND SYSTEM INCLUDING SAME

(75) Inventors: Joshua Ziff, Export, PA (US); Joseph R. Acquaviva, Gibsonia, PA (US); Chien Hung Wu, Strongsville, OH (US); William Jan, Mars, PA (US); Charles Buenzli, Wake Forest, NC (US); Nelson Kuan, Reston, VA (US)

Correspondence Address: REED SMITH LLP, P.O. BOX 488, PITTSBURGH, PA, 15230-0488, US

(73) Assignee: Bridge Semiconductor Corporation, Pittsburgh, PA (US)

(21) Appl. No.: 12/755,011

(22) Filed: Apr. 6, 2010

Related U.S. Application Data
(60) Provisional application No. 61/167,065, filed on Apr. 6, 2009.

(51) Int. Cl. H02G 3/00; H01B 5/14

(52) U.S. Cl. 174/70 R; 174/126.4

(57) ABSTRACT

An interconnect. The interconnect includes a thermal isolation structure and a layer of conductive material which covers the thermal isolation structure. The thermal isolation structure has a first end, a second end, and a sidewall.

### CROSS-REFERENCE TO RELATED APPLICATION

This application claims the benefit under 35 U.S.C. §119(e) of the earlier filing date of U.S. Provisional Patent Application No. 61/167,065 filed on Apr. 6, 2009, the contents of which are hereby incorporated by reference in their entirety.

### BACKGROUND

This application discloses an invention which is related, generally and in various embodiments, to an interconnect and a system including the interconnect.

In thermal imaging systems, a thermal sensor is utilized to detect a small difference in a scene temperature and convert the difference to electrical signal (e.g., current or voltage). The electrical signal is then transmitted to a signal conditioning circuit via an interconnect between the thermal sensor and the readout circuit. For the thermal imaging system to function effectively, the interconnect serves to thermally isolate the thermal sensor from the readout circuit and to electrically connect the thermal sensor to the readout circuit. In general, the more sensitive the thermal sensor, the more important it is to maintain thermal isolation between the thermal sensor and the readout circuit.

For thermal imaging systems which utilize a microbolometer as the thermal sensor, the microbolometer is typically formed with metalized arms which serve as the interconnect between the thermal sensor and the readout circuit. The metalized arms lie in the same plane as the sensing surface of the thermal sensor, thereby increasing the effective footprint of the thermal sensor. The larger effective footprint operates to decrease the fill factor and pixel density of the thermal imaging system, thereby negatively impacting the overall size of the thermal imaging system.

### SUMMARY

In one general respect, this application discloses an interconnect. According to various embodiments, the interconnect includes a thermal isolation member and a layer of conductive material. The thermal isolation member has a first end, a second end, and a sidewall. The layer of conductive material covers the thermal isolation member.

In another general respect, this application discloses a system. According to various embodiments, the system includes a thermal sensor, an interconnect, and a readout circuit. The interconnect is connected to the thermal sensor and includes a thermal isolation member and a layer of conductive material. The thermal isolation member has a first end, a second, and a sidewall. The layer of conductive material covers the thermal isolation member. The readout circuit is connected to the interconnect.

Aspects of the invention may be implemented by a computing device and/or a computer program stored on a computer-readable medium. The computer-readable medium may comprise a disk, a device, and/or a propagated signal.

### BRIEF DESCRIPTION OF THE DRAWINGS

Various embodiments of the invention are described herein in by way of example in conjunction with the following figures, wherein like reference characters designate the same or similar elements.

FIG. 1 illustrates a high-level representation of a system according to various embodiments;

FIG. 2 illustrates a thermo-electric model of a sensor of the system of FIG. 1;

FIG. 3 is an illustrative example of temperature changes of the sensor of FIG. 1 due to a chopping process;

FIG. 4 illustrates a high-level representation of a readout circuit according to various embodiments of the system of FIG. 1;

FIG. 5 illustrates various embodiments of a charge amplification circuit of the readout circuit of FIG. 4;

FIG. 6 illustrates other embodiments of a charge amplification circuit of the readout circuit of FIG. 4;

FIG. 7 illustrates various embodiments of an analog-to digital conversion circuit of the readout circuit of FIG. 4;

FIG. 8 illustrates various embodiments of the system of FIG. 1;

FIG. 9 illustrates various embodiments of an interconnect of the system of FIG. 1; and

FIG. 10 illustrates various embodiments of the system of FIG. 1.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

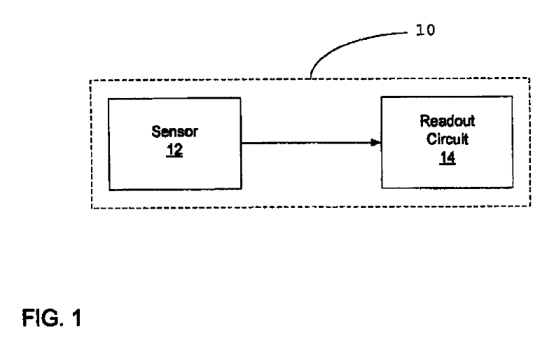

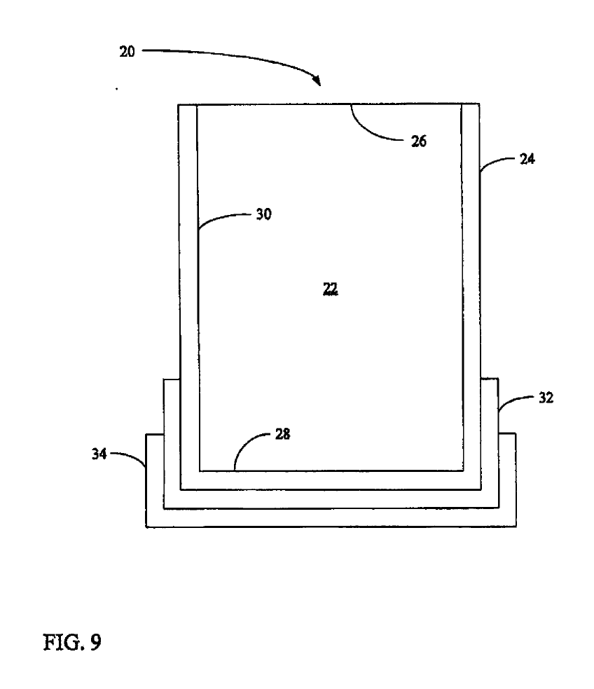

FIG. 1 illustrates a high-level representation a system 10. According to various embodiments, the system 10 includes a sensor 12, and a readout circuit 14 connected to the sensor 12. A detailed description of the connection between the sensor 12 and the readout circuit will be described in more detail hereinbelow with respect to FIG. 9. Although only one sensor 12 and one readout circuit 14 are shown in FIG. 1, it will be appreciated that the imaging system 10 may include a plurality of sensors 12 and a plurality of readout circuits 12. Each sensor 12 may be considered to be an individual pixel.

The sensor 12 may be embodied as any suitable type of sensor. According to various embodiments, the sensor 12 is a thermal sensor such as, for example, a thin-film Lead Zirconate Titanate (PZT) sensor. For purposes of simplicity, the system 10 will be described in the context of an imaging system having thermal sensors. However, it is understood that the system 10 may include any type and any number of sensors 12.

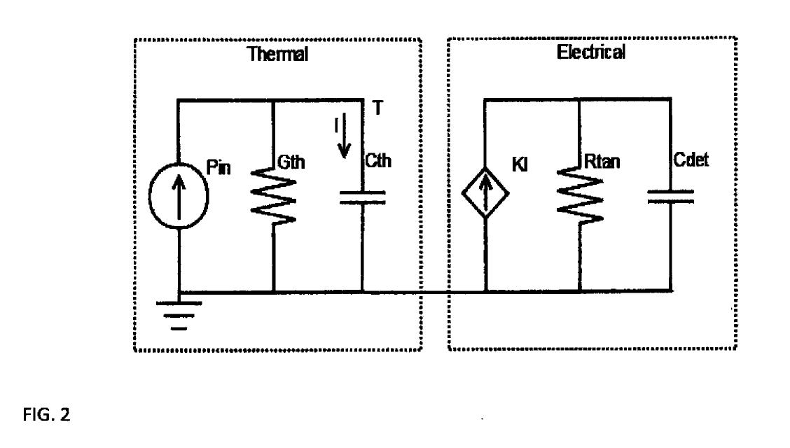

FIG. 2 illustrates a thermo-electric model of the thermal sensor 12 according to various embodiments. In general, a pyroelectric device such as the thermal sensor 12 utilizes a change in temperature in order to generate a useful signal. For example, objects in a scene of interest radiate energy to achieve thermal equilibrium with the environment, and it is this thermally generated radiation that is of interest to the thermal sensor 12. Simplistically, objects will radiate according to Planck's Blackbody Law:

$$I ( λ , T ) = \frac{2 {hc}^{2}}{{λ}^{5}} \frac{1}{{e}^{\frac{hc}{λ KT}} - 1} \qquad ( 1 )$$

where

I(λ, T)=spectral radiance per unit (time, wavelength, and solid angle)

h=Planck's constant

c=the speed of light

λ=wavelength

k=Boltzmann constant

In order to best detect an object in a given thermal scene, the object should stand out thermally from the background, therefore the difference in spectral radiance is a parameter of interest, and can be represented by the following equation:

ΔI=I(λ,Tₒ)−I(λ,T_{B}) (2)

where

Tₒ=temperature of the object

T_{B}=temperature of the background

It follows from equation (1) and equation (2) that:

$$Δ I ( λ , Δ T ) = {\int }_{{λ}_{1}}^{{λ}_{2}} \{ \frac{2 {hc}^{2}}{{λ}^{5}} \frac{1}{\frac{1}{{e}^{\frac{hc}{λ {KT}_{o}}} - 1}} \} d λ - {\int }_{{λ}_{1}}^{{λ}_{2}} \frac{2 {hc}^{2}}{{λ}^{5}} \frac{1}{\frac{1}{{e}^{\frac{hc}{λ {KT}_{o}}} - 1}} d λ \qquad ( 3 )$$

Equation (3) represents the incident power when integrated over wavelengths of interest. For a given thermal sensor 12, the value derived from equation (3) may be adjusted by the absorption efficiency of the pyroelectric material (η) of the thermal sensor 12, and may also be adjusted based on the lens and window transmission efficiency of the thermal sensor 12.

As the thermal sensor 12 operates under the pyroelectric effect, the thermal sensor 12 utilizes a change in temperature to produce a change in charge. Thermally, the thermal sensor 12 can be modeled as shown in FIG. 2. The power incident to the thermal sensor 12 is modeled as a current source Pᵢₙ, the thermal conductance of the thermal sensor 12 is modeled as Gₜₕ, and the thermal capacitance of the thermal sensor 12 is modeled as Cₜₕ. The temperature of the thermal sensor 12 can be derived from the following equation using frequency domain:

$$T = \frac{{P}_{t n}}{{Y}_{eq}} = \frac{{P}_{in}}{{G}_{th} + {sC}_{th}} \qquad ( 4 )$$

where

Y_{eq}=the thermal admittance of the PZT sensor

s=the Laplace transform variable

As power (i.e., thermal radiation) is incident to the thermal sensor 12, the temperature of the thermal sensor 12 increases. If the power incident to the thermal sensor 12 is uninterrupted, the temperature of the thermal sensor 12 may reach a steady state value (e.g., a saturation temperature) after a period of time. Since the detector responds to a change in temperature, the system 10 may utilize a chopping system to modulate the power incident to the thermal sensor 12. In general, the chopping system periodically blocks the power incident to the thermal sensor 12, thereby periodically changing the temperature of the thermal sensor 12. The frequency of the blocking of the power incident to the thermal sensor 12 may be referred to as the chopping frequency.

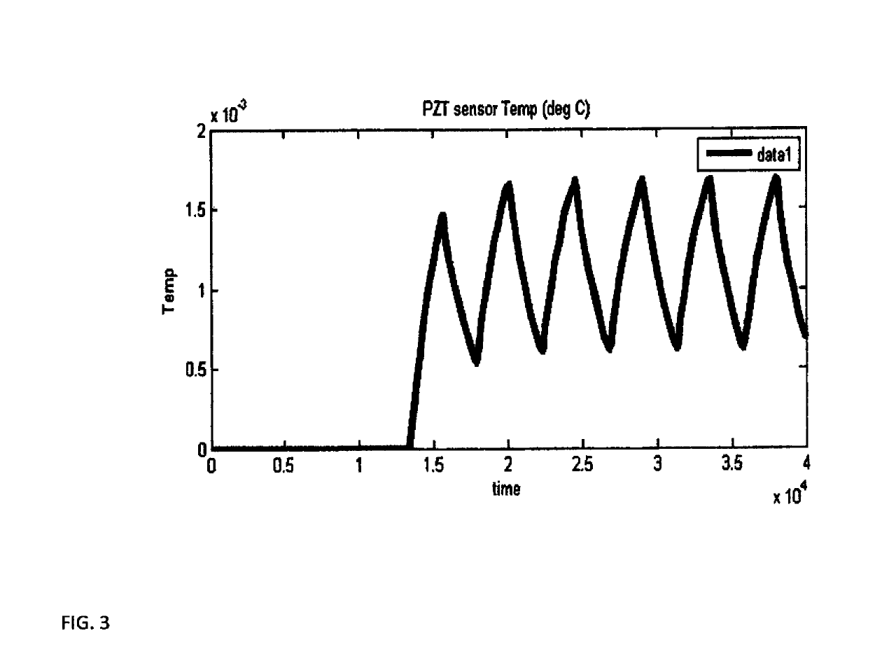

An illustrative example of the temperature changes of the thermal sensor 12 due to chopping is shown in FIG. 3. By modulating the incident power at the chopping frequency, the peak-to-peak value of the temperature of the thermal sensor 12 is reduced and does not reach steady state values. The magnitude of the peak-to-peak amplitude is related to the steady-state amplitude by the following equation:

$$Δ {T}_{chop} = Δ {T}_{max} tanh ( \frac{1}{4 {f}_{c} {τ}_{th}} ) \qquad ( 5 )$$

where

ΔT_{chop}=reduction in peak temperature

ΔTₘₐₓ=peak unchopped temperature

f_{c}=chopping frequency

τₜₕ=thermal time constant

For f_{c}=30 Hz and τₛₕ=16 ms, the chopping reduces the peak temperature of the thermal sensor 12 by a maximum of approximately 48%. As shown in FIG. 3, the peak to peak chop temperature is 1 mK, and this corresponds to a ΔQ of 0.4 femtocoulombs since charge is related to temperature difference by the following equation:

ΔQ=ρAₑₗΔT (6)

where

ΔQ=change in pyroelectric charge

ρ=pyroelectric coefficient (200 μC/m²K)

Aₑₗ=electrical area of the pixel (2×10⁻⁹ m²)

ΔT=change in pixel temperature

Electrically, the thermal sensor 12 can be modeled as shown in FIG. 2, where KI is a current source used to model the pyroelectric current, Rₜₐₙ describes real losses in the dielectric material, and C_{det} is the intrinsic capacitance of the sensor 12.

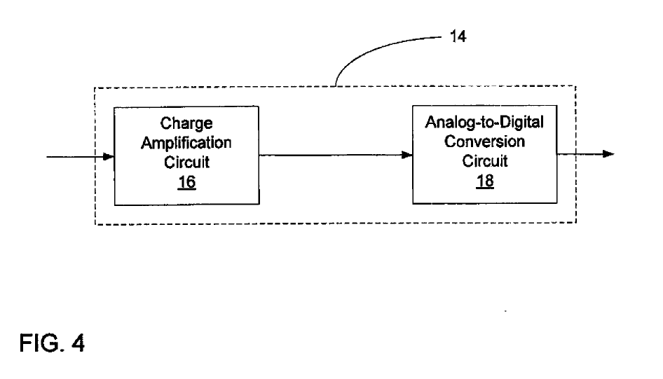

FIG. 4 illustrates a high-level representation of the readout circuit 14. According to various embodiments, the readout circuit 14 includes a charge amplification circuit 16 connected to the thermal sensor 12, and an analog-to-digital conversion circuit 18 connected to the charge amplification circuit 16.

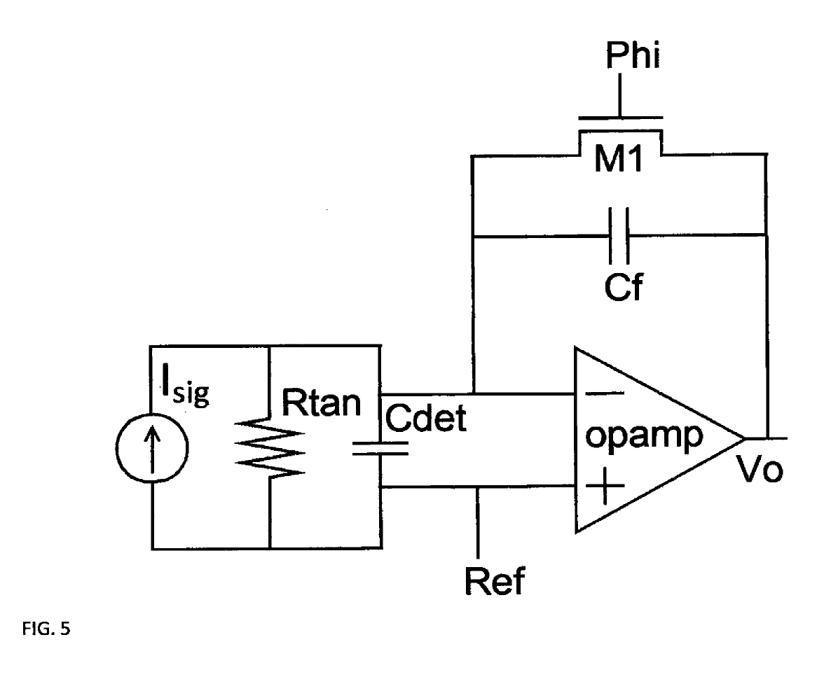

FIG. 5 illustrates various embodiments of the charge amplification circuit 16. The charge amplification circuit 16 includes an operational amplifier, a capacitor C_{f}, and a CMOS transmission gate M1. For purposes of simplicity, the CMOS transmission gate M1 is shown as a field-effect transistor. The operational amplifier has two input terminals (a non-inverting + and an inverting −) connected to the thermal sensor 12, and an output terminal connected to the analog-to-digital conversion circuit 18. The capacitor C_{f} and the CMOS transmission gate M1 are each connected between the inverting terminal of the operation amplifier and the output terminal of the operational amplifier. As shown in FIG. 5, the inverting terminal of the operational amplifier may be connected to a voltage source (Ref), and the charge, amplification circuit 16 is configured as a capacitive trans-impedance amplifying circuit.

In operation, as the thermal sensor 12 heats and cools based on the incident radiation and the chopping, the thermal sensor 12 injects pyroelectric charge into the charge amplification circuit 16. This charge flows into the capacitor C_{f} and to the inverting input terminal of the operational amplifier 18. The operational amplifier differentially amplifies the charge to adjust the output voltage of the operation amplifier to sustain the charge at the capacitor C_{f}. Due to the differential amplification, the charge amplification circuit 16 of FIG. 5 also operates to cancel common mode signals, and to cancel common mode noise. The differential architecture also minimizes the undesirable effects of clock feed through (e.g., charge leaking from the gate of the field-effect transistor to the drain and/or source of the field-effect transistor when the gate voltage is driven low) and charge injection (e.g., charge flowing from the channel of the field-effect transistor to the drain and/or source of the field-effect transistor after power to the gate of the field-effect transistor is interrupted).

If the voltage gain of the operational amplifier is made large enough, the capacitance at C_{f} will dominate C_{det} due to the Miller effect, and current will flow from the thermal sensor 12 to the capacitor C. The output voltage (Vₒ) of the operational amplifier is given by the following equation:

$${V}_{o} = \frac{{Q}_{det}}{{C}_{f}} ≅ \frac{2 ρ {A}_{el} Δ T}{{C}_{f}} provided ( 1 + {A}_{o} ) {C}_{f} >> {C}_{det} ;$$

$$where$$

$${A}_{o} is the open loop voltagegain$$

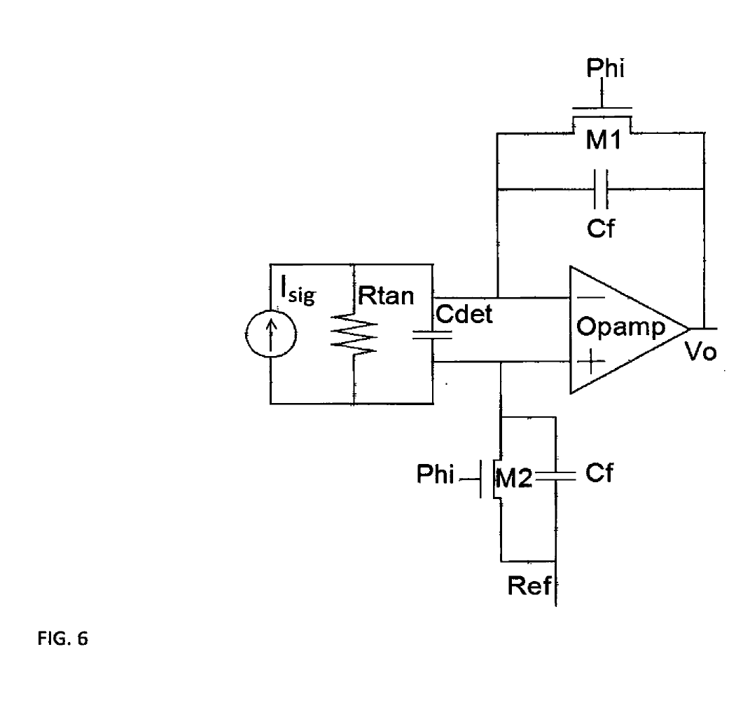

FIG. 6 illustrates other embodiments of the charge amplification circuit 16. As shown in FIG. 6, for such embodiments, the charge amplification circuit 16 includes an operational amplifier, a first capacitor C_{f}, a second capacitor C_{f}, a first CMOS transmission gate M1, and a second CMOS transmission gate M2. For purposes of simplicity, the first and second CMOS transmission gates M1, M2 are shown as field-effect transistors. The operational amplifier has two input terminals (a non-inverting + and an inverting −) connected to the thermal sensor 12, and an output terminal connected to the analog-to-digital conversion circuit 18. The first capacitor C_{f} and the first CMOS transmission gate M1 are each connected between the inverting terminal of the operation amplifier and the output terminal of the operational amplifier. The second capacitor C_{f} and the second CMOS transmission gate M2 are each connected to the non-inverting terminal of the operation amplifier. As shown in FIG. 6, the second capacitor C_{f} and the second CMOS transmission gate M2 may also be connected to a voltage source (Ref).

In some respects, the operation of the charge amplification circuit 16 of FIG. 6 is similar to the operation of the charge amplification circuit of FIG. 5. In general, a reset transition on the first and second CMOS transmission gates M1, M2 will couple charge (common mode) into the inverting and non-inverting terminals of the operational amplifier, thereby reducing its effect by the common mode rejection ratio of the operational amplifier. The charge amplification circuit 16 of FIG. 6 also operates to periodically cancel the offset associated with the operational amplifier, to periodically cancel drift associated with the operational amplifier, and to periodically cancel low frequency noise.

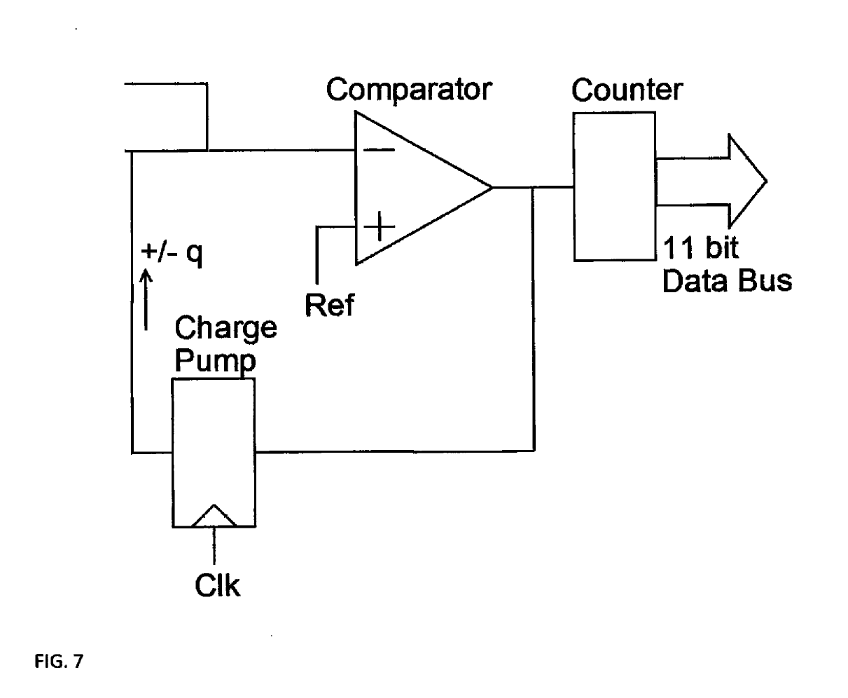

FIG. 7 illustrates various embodiments of the analog-to-digital conversion circuit 18 of the readout circuit 14. According to various embodiments, the analog-to-digital conversion circuit 18 is embodied as a sigma delta modulator circuit having a comparator and a charge pump. As shown in FIG. 7, the analog-to-digital conversion circuit 18 also includes a counter. According to various embodiments, the counter may be considered as part of the sigma delta modulator circuit.

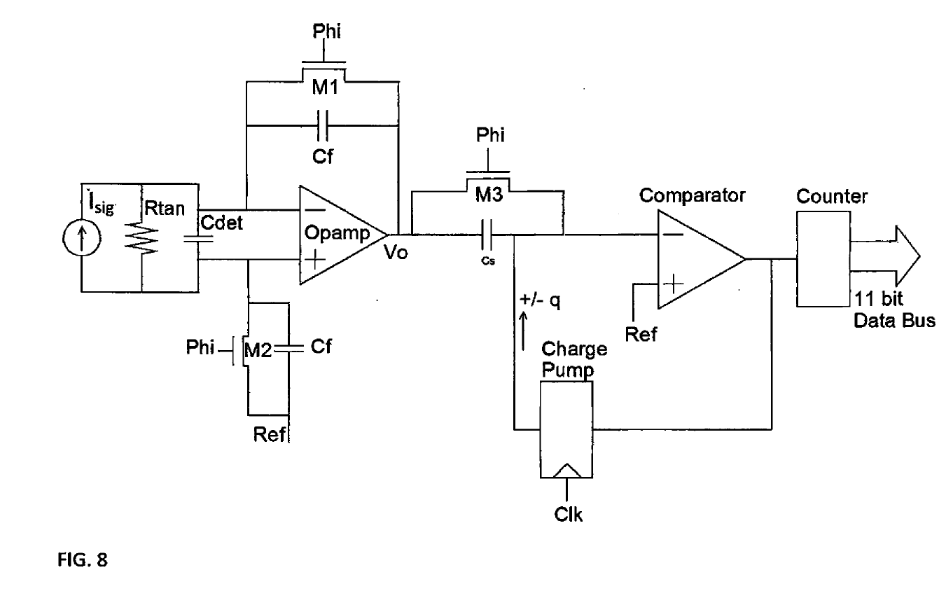

FIG. 8 illustrates various embodiments of the system 10. As shown in FIG. 8, the readout circuit 14 also includes a capacitor Cₛ and a third CMOS transmission gate M3. For purposes of simplicity, the third CMOS transmission gate M3 is shown as a field-effect transistor. According to various embodiments, the capacitor Cₛ and a third CMOS transmission gate M3 may be considered as part of the charge amplification circuit 16. According to other embodiments, the capacitor Cₛ and a third CMOS transmission gate M3 may be considered as part of the analog-to-digital conversion circuit 18 (e.g., as part of the sigma delta modulator circuit).

In operation, the readout circuit 14 of FIG. 8 operates as described hereinabove with respect to the charge amplification circuit 16 of FIG. 6. Based on the output voltage (Vₒ) of the operational amplifier, the charge on the capacitor Cₛ is equal to Vₒ*Cₛ, and is subsequently counted by the 1-bit sigma delta modulator circuit. The sigma delta modulator circuit will attempt to maintain the inverting terminal of the comparator at a voltage equal to V_{Ref} by delivering packets of charge ±q at the converter clock rate. The 11-bit counter tallies charge steps, and a digital representation of the input charge tally is recorded and delivered to the data bus. Each thermal sensor 12 is read during the light and dark phases of the chop cycle and a difference is taken digitally before resetting the clocking signal (Phi). This has the effect of imposing a correlated double sampling (CDS) process on the output data thereby reducing system offsets and reset noise.

FIG. 9 illustrates various embodiments of an interconnect 20 of the system 10 of FIG. 1. The interconnect 20 operates to thermally isolate the thermal sensor 12 from the readout circuit 14, and to electrically connect the thermal sensor 12 to the readout circuit 14. The interconnect 20 includes a thermal isolation member 22, and a layer of electrically conductive material 24 covering the thermal isolation member 22.

The thermal isolation member 22 may be fabricated in any suitable size and shape from any suitable material. As shown in FIG. 9, according to various embodiments, the thermal isolation member 22 is substantially cylindrical and includes a first end 26, a second end 28, and a sidewall 30. According to various embodiments, the thermal isolation member 22 may have a height in the range of approximately 15 μm to 40 μm and an aspect ratio on the order of approximately 30:1. Although the thermal isolation member 22 is shown as being substantially cylindrical in FIG. 8, it is understood that according to other embodiments, the sidewall 30 of the thermal isolation member 22 may be tapered. For such embodiments, a cross-sectional area at the first end 26 of the thermal isolation member 22 is greater than a cross-sectional area at the second end 28 of the thermal isolation member 22. According to various embodiments, the thermal isolation member 22 is fabricated from a polymer such as, for example, a negative photoresist such as SU-8.

The layer of conductive material 24 may be of any suitable thickness and may be fabricated from any suitable material. For example, according to various embodiments, the layer of conductive material 24 is a layer of a nickel-chromium alloy approximately 100-300 angstroms thick, and covers the second end 28 and the sidewall 30 of the thermal isolation structure 22.

As shown in FIG. 9, according to various embodiments, the interconnect 20 may also include an adhesion layer 32 which covers at least a portion of the layer of conductive material 24. The adhesion layer 32 may be of any suitable thickness and may be fabricated from any suitable material. For example, according to various embodiments, the adhesion layer 32 is a layer of a niobium or chromium approximately 500 to 2000 angstroms thick, and covers at least a portion of the layer of conductive material 24 (e.g., the portion proximate the second end 28 of the thermal isolation member 22).

Additionally, as shown in FIG. 9, according to various embodiments, the interconnect 20 may further include a contact layer 34 which covers at least a portion of the adhesion layer 32. The contact layer 34 may be of any suitable thickness and may be fabricated from any suitable material. For example, according to various embodiments, the contact layer 34 is a layer of gold approximately 300 to 2000 angstroms thick, and covers at least a portion of the adhesion layer 32 (e.g., the portion proximate the second end 28 of the thermal isolation member 22).

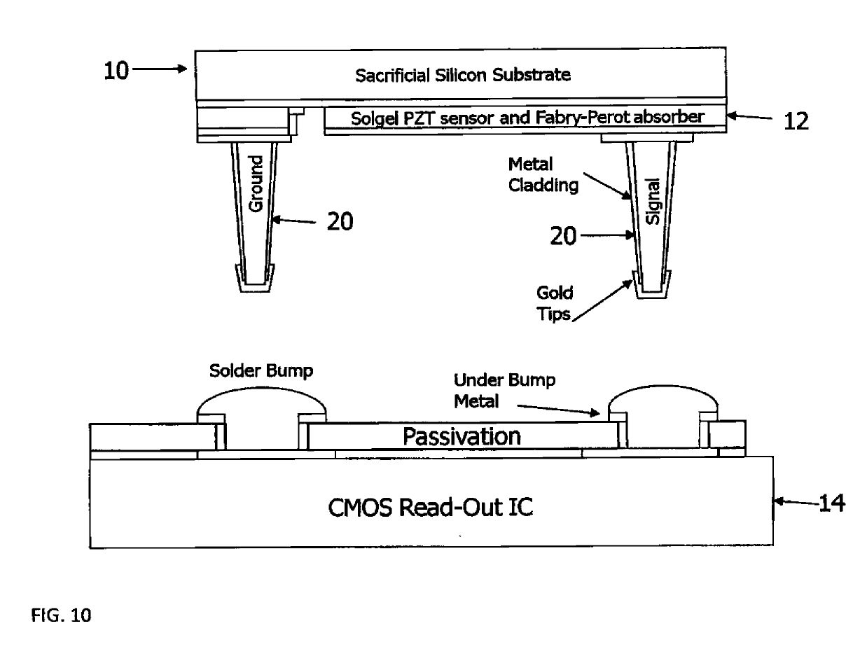

FIG. 10 illustrates various embodiments of the system 10 of FIG. 1, wherein the system 10 includes the interconnect 20. As described hereinabove, the system 10 may include any number of thermal sensors 12 and any number of readout circuits 14. As shown in FIG. 10, for each thermal sensor 12, the system 10 includes two interconnects 20, one which serves to transmit the signal generated at the thermal sensor 12, and one which serves as a ground. For purposes of clarity, the system 10 is shown in a partially exploded view and the adhesion layer 32 is not shown in FIG. 10.

In general, according to various embodiments, the interconnects 20 may be formed integral with the thermal sensors 12, then brought into alignment and contact with solder bumps connected to the readout circuit 14 (e.g., connected to the first and second input terminals of the operational amplifier of the charge amplification circuit 16 of the readout circuit 14). The connection between the thermal sensor 12 and the readout circuit 14 may then be established by melting the solder to form connections between the two interconnects 20 the readout circuit 14.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof.

What is claimed is:

1. An interconnect, comprising:
a thermal isolation member having a first end, a second end, and a sidewall; and
a layer of conductive material which covers the thermal isolation member.

2. The interconnect of claim 1, wherein the thermal isolation member comprises a polymer.

3. The interconnect of claim 2, wherein the polymer is a photoresist.

4. The interconnect of claim 3, wherein the photoresist is a negative photoresist.

5. The interconnect of claim 4, wherein the negative photoresist is SU-8.

6. The interconnect of claim 1, wherein the thermal isolation member is substantially cylindrical.

7. The interconnect of claim 1, wherein the thermal isolation member is a tapered thermal isolation member.

8. The interconnect of claim 7 wherein a cross-sectional area at the first end of the thermal isolation member is greater than a cross-sectional area at the second end of the thermal isolation member.

9. The interconnect of claim 1, wherein the layer of conductive material covers:
the sidewall of the thermal isolation member; and
the second end of the thermal isolation member.

10. The interconnect of claim 1, wherein the layer of conductive material comprises a nickel-chromium alloy.

11. The interconnect of claim 1, further comprising an adhesion layer which covers the layer of conductive material.

12. The interconnect of claim 11, wherein the adhesion layer covers the layer of conductive material proximate the second end of the thermal isolation structure.

13. The interconnect of claim 11, wherein the adhesion layer comprises one of the following:
niobium; and
chromium.

14. The interconnect of claim 11, further comprising a contact layer which covers the adhesion layer.

15. The interconnect of claim 14, wherein the contact layer comprises gold.

16. A system, comprising:
a thermal sensor;
an interconnect connected to the thermal sensor, wherein the interconnect comprises:
a thermal isolation member having a first end, a second, and a sidewall; and
a layer of conductive material which covers the thermal isolation member; and
a readout circuit connected to the interconnect.

17. The system of claim 16, wherein the system further comprises:
a plurality of thermal sensors;
a plurality of interconnects, wherein each thermal sensor is connected to a different pair of interconnects; and
a plurality of readout circuits, wherein each readout circuit is connected to a different pair of interconnects.
